(19) United States
(12) Patent Application Publication
(10) Pub. No.: US 2013/0340924 A1
(43) Pub. Date: Dec. 26, 2013

(54) SHAPING THE CROSS-SECTION OF AN EXTRUDED STRIP

(71) Applicant: Gilles Mioche, Clermont-Ferrand Cedex 9 (FR)

(72) Inventor: Gilles Mioche, Clermont-Ferrand Cedex 9 (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/984,994

(22) PCT Filed: Feb. 6, 2012
(86) PCT No.: PCT/EP12/51956

§ 371 Date: Sep. 11, 2013

(30) Foreign Application Priority Data
Feb. 15, 2011 (FR) 1151222

(51) Int. Cl. B29C 47/00

(52) U.S. Cl. CPC B29C 47/0064
USPC 156/184

(57) ABSTRACT

Method for laying a band of elastomer of given width and given mean thickness on a receiving surface, comprising a step during the course of which a leader of elastomer band of given length, the neutral fibre of the cross section of which has a non-zero curvature, is extruded through a die, the said leader being supported only by its end positioned on the die side, characterized in that the band is orientated in such a way that the concave side of the said neutral fibre faces away from the orientation of the gravitational field, so as to prevent the leader from collapsing under the effect of gravity.

### BACKGROUND

1. Field

The invention relates to the field of tire manufacture and more particularly to the extrusion of a band of rubber that is intended to be wound for several turns, in an ordered and predetermined manner, onto a receiving surface to form a profiled element that constitutes one of the components of a green tire.

2. Description of Related Art

Such bands are generally manufactured using an extrusion means, for example using an extrusion nozzle comprising a chamber in which the compound is pressurized and an outfall or a die, generally stationary, through which the compound that makes up the band is expelled with a given transverse profile.

During the step of starting this manufacturing operation it is necessary to bring the outlet of the nozzle as close as possible to the receiving surface and to cause a leader of band generated for this purpose or resulting from the previous laying operation, to adhere to the receiving surface. This residual length of band is, as a general rule, short in length.

Once this leader has been applied to the receiving surface, the winding operation can then be re-started by setting the laying surface in relative motion with respect to the extrusion nozzle, and the successive turns can then be applied in the desired sequence in order to obtain the required component profile.

However, when applying the receiving surface a fold may be produced and this is liable to cause a local modification to the component profile.

This phenomenon can be better understood by referring to FIGS. 1 to 3.

The strip laying device comprises an extrusion means 1 formed of a body 11 in which a screw 12 is turned to progress and pressurize and elastomeric compound in a pressurizing chamber 14. The pressurizing chamber opens onto an outlet die 13 through which the compound flows, adopting a transverse profile that is imposed on it by the transverse profile of the said outlet die. A press roller may be provided to encourage the band to join to itself or to the laying surface.

Under normal operating conditions, the band is applied to the receiving surface via its lower face D.

When no precautions are taken when bringing the nozzle in as close as possible to the receiving surface 3, the leader, which has no means of support, collapses and forms a fold with the result that it is the upper face U of the band that comes into contact with the receiving surface, as illustrated in FIG. 2.

A number of solutions have been developed in order to reduce this phenomenon.

A first approach is to set the receiving surface in relative motion with respect to the extrusion means during the contacting operation. However, this solution has not been adopted because it is necessary to take steps to ensure that the leader adheres to the receiving surface and therefore to slow this relative motion, before beginning the actual operation proper of winding and applying the band B.

Another solution is to provide an air-blowing means 4, suitably directed, and able to blast pressurized air towards the leader A, so as to cause the leader to come into contact with the receiving surface via its lower face D, with a view to avoiding the creation of the fold as illustrated in FIG. 3.

Although satisfactory, this solution is still bulky and requires the installation of a compressed air supply pipe as close as possible to the nozzle outlet.

### SUMMARY

It is an object of the invention to propose an alternative to these known solutions which makes it possible to avoid the formation of this fold while at the same time offering great ease of use.

When, for one reason or another, the profile of the band was slightly curved, it has been found that the band twists slightly about the lip of the die positioned on the same side as the centre of curvature. This twisting has a tendency to fold the band around the lip.

It is an object of the invention to put this physical phenomenon to good use in order to cause the leader of the band leaving the die to pivot in the desired direction and thereby prevent the leader from collapsing in an uncontrolled direction.

To make the invention easier to describe, the neutral fibre of the cross section of the band is defined as being the locus of the centres of gravity of the straight sections of the said surface. These centres of gravity are situated in the middle of the straight segments formed by the intersection of straight lines substantially parallel to the direction OY with the contour of the cross section of the band. These centres of gravity form a continuous line also known as the neutral fibre or neutral axis.

The invention, the subject of which is a method for laying a band of elastomer of given width and given mean thickness on a receiving surface, comprises a step during the course of which a leader of elastomer band of given length, the neutral fibre of the cross section of which has a non-zero curvature, is extruded through a die, the said leader being supported only by its end positioned on the die side.

This method is characterized in that the band is orientated in such a way that the concave side of the said neutral fibre faces away from the orientation of the gravitational field, so as to prevent the leader from collapsing in the direction of the receiving surface under the effect of gravity.

This method proves to be particularly attractive when the radius of curvature R of the neutral fibre is greater than fifteen times the width of the band.

Advantageously, the ratio of the width to the thickness of the band is comprised between three and thirty, and preferably between five and twenty.

This method makes it possible, for a band of given mean thickness, to adjust the length of the leader in a way that is inversely proportional to the value of the radius of curvature of the neutral fibre.

The method may advantageously provide a step during the course of which the extrusion means are brought in close above the receiving surface so that the face of the said leader which is positioned on the convex side of the neutral fibre is applied directly to the said receiving surface.

Still according to the method, the receiving surface is in relative motion with respect to the extrusion means.

Advantageously, the receiving surface is a rotating cylinder onto which turns of band are wound in a given order.

### BRIEF DESCRIPTION OF THE DRAWINGS

The physical phenomena put to good use by the invention will be better understood from the following explanations supported by FIGS. 4 to 6, in which:

FIGS. 1 and 2 (reminder) are illustrations of the problem that the invention seeks to solve

FIG. 3 (reminder) is a solution known from the prior art,

FIG. 4 is an illustration of the flows of material in the tip of the nozzle,

FIG. 5 is an illustration of one embodiment of the method according to the invention,

FIG. 6 is an illustration of possible band forms that can be used in a method according to the invention.

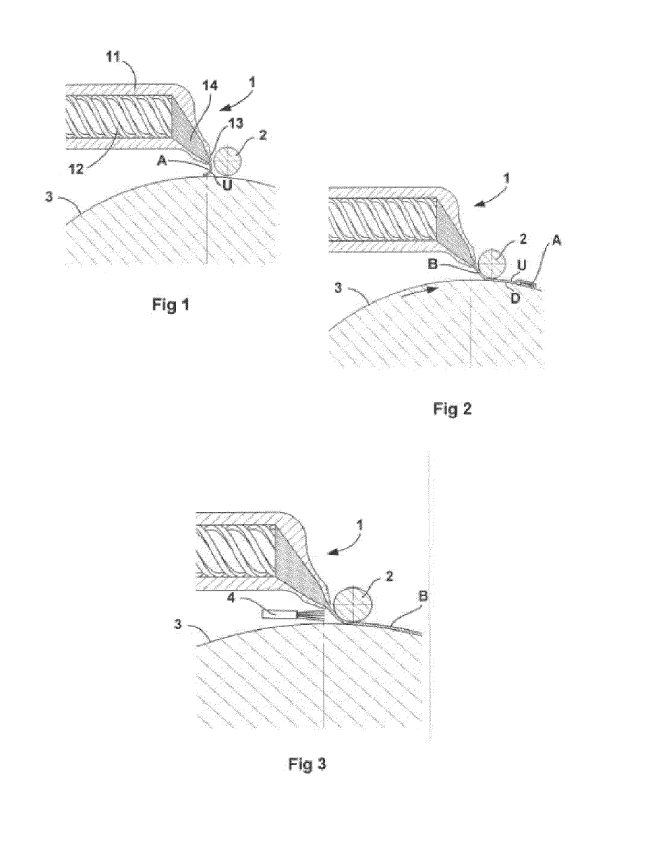

### DETAILED DESCRIPTION OF SPECIFIC EMBODIMENTS

As already mentioned hereinabove, FIG. 1 depicts a laying device comprising extrusion means and a receiving surface in relative motion with respect to the said extrusion means. In this particular instance, the receiving surface is formed by a cylinder of circular section rotating with respect to its axis.

The extrusion means, in the exemplary embodiment of the invention being described here, comprise an extrusion nozzle 13 positioned as close as possible to the receiving surface 3 without, however, coming into contact with the latter. The nozzle moves axially with respect to the receiving surface according to a predetermined algorithm. The compound is expelled through the outlet die 130 of the nozzle 13 under the effect of the pressure generated by an extruder or by any other means such as a positive displacement pump or even a piston.

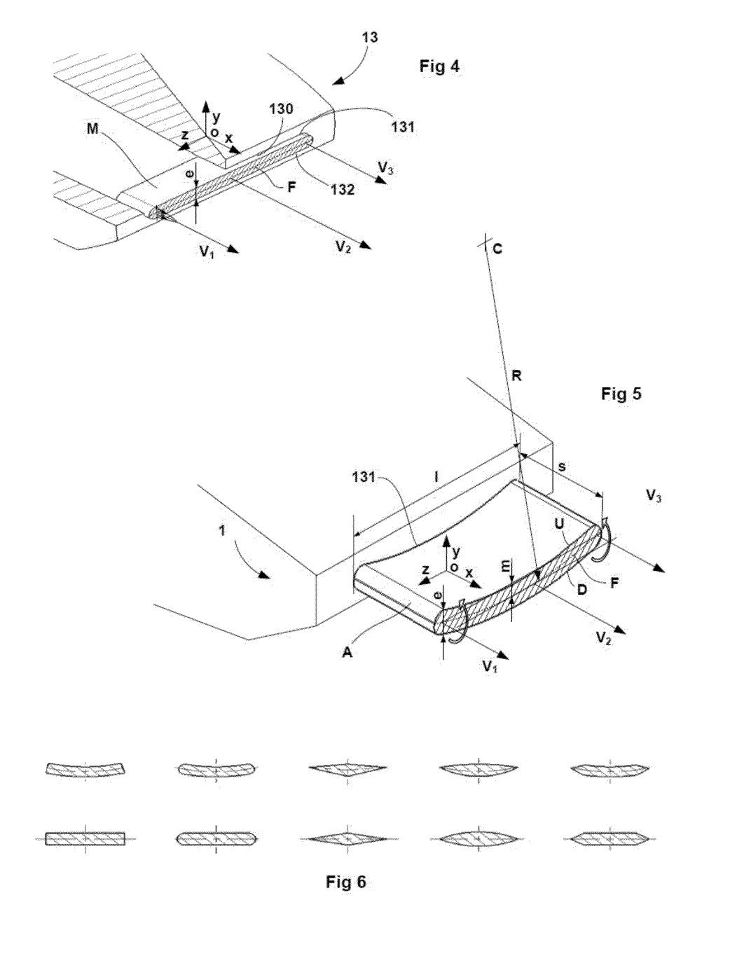

FIG. 4 is a detailed view of the head of the nozzle which illustrates the extrusion of a compound M through the die 130. The shape of the cross section of the die dictates the shape of the cross section of the strip, which is the equivalent to the cross section of the strip in a plane OYZ perpendicular to the longitudinal direction OX of the band. In the scenario illustrated in FIG. 4, the cross section of the band is symmetric about the axes OX and OZ.

The band has a cross section the thickness e of which is small with respect to its width I.

The neutral fibre F of the cross section of the band is formed, as indicated hereinabove, by the centres of gravity of the straight sections. Its radius of curvature is large with respect to the width of the said band. The straight sections are perpendicular to the neutral fibre; in this particular instance they are parallel to the direction OY. Likewise, the dimension of the straight segments is small when compared with the width of the band; in this particular instance, these sections are equal to the thickness e of the band in the direction OY.

When considering the distribution of flow velocities along the straight sections of the cross section of the band, progressing from the upper lip 131 of the nozzle towards the lower lip 132 of the nozzle, it is found that, when the extrusion rate is steady, these velocities adopt a symmetric distribution (as illustrated for V₁), centred more or less on the neutral fibre F.

The vectors V₁, V₂ and V₃ represent the value of the velocity vectors for the flow of the compound respectively, according to the transverse position of the section of band, at one edge, in the centre and at the other edge. These vectors run parallel to the direction of flow OX.

Because of the friction of the compound against the walls of the die 130, the flow velocities at the edges, velocities V₁ and V₃, are slightly lower than the flow velocity V₂ at the centre of the section. As a general rule, the velocities V₁ and V₃ are equal.

In the case illustrated in FIG. 4, and under steady extrusion conditions, all the velocity vectors are collinear with the direction of flow, and the neutral fibre F is substantially rectilinear. As a result, the band leaves the die 130 without deviating from its path, parallel to the direction OX.

FIG. 5 provides a visual representation of the phenomenon involved in the method according to the invention. In this embodiment, the neutral fibre F has a curvature of radius R, the centre of curvature C of which is situated on the same side as the upper face U of the band.

It may be seen that on leaving the die, the band experiences a slight twisting, embodied by the lateral arrows, which has the effect of causing the leader A to pivot about the upper lip 131. This twisting is barely noticeable when the band is being continuously extruded. However, when a band of very short length s is extruded, such as a leader A intended to lead the application of the band to the receiving surface, it is possible to put this phenomenon to good use.

Because the leader A is free to move in space and is supported only by its end which is positioned on the same side as the die 13, the differences in flow velocity of the compound leaving the die at the middle (V1) by comparison with the edges (V₁,V₃), combined with the fact that there is a slight raising m of the edges with respect to the centre on the same side as the centre of curvature of the neutral fibre, have the effect of raising the band in the direction of the concave side in order to bring the internal flows and stresses into balance.

This effect combines with the greater mechanical strength structurally associated with the actual concave shape of the neutral fibre. However, this effect, known from the strength of materials, is of secondary importance when the radius of curvature of the neutral fibre is relatively great with respect to the width of the band, and would not be sufficient in itself to explain the high integrity of the leader.

Hence, it would appear to be particularly advantageous to put the physical phenomenon described hereinabove to good use when the radius of curvature R of the band is greater than fifteen times, or even twenty times, the width I of the band.

In order to avoid the phenomena of collapse all that is then required is for the leader to be orientated in such a way that the concave side of the neutral fibre is positioned substantially in a direction that is opposite to the direction of the gravitational field the effect of which then has a tendency to introduce a twisting in the opposite direction to the twisting generated by the curvature of the neutral fibre.

It will be readily understood that the lower the radius of curvature the higher will be the straightening-out twisting effect associated with the curvature, and the higher will be the structural effects associated with the curvature itself, and the more possible it will be to increase the length s of the leader A.

Although this phenomenon manifests itself regardless of the thickness and width of the band, this phenomenon proves to be particularly advantageous when the width of the band is comprised between three and fifteen times the thickness of the said band, and preferably comprised between five and ten times the thickness of the said band. What happens is that if the width is too great, the elastic forces have the effect of stretching out the edges of the band, the consequence of this being to reduce the radius of curvature of the neutral fibre, and if the width is too small, the phenomenon no longer appears.

Through a judicious orientation of the position of the centre of curvature, on the opposite side to the face of the band that is intended to come into contact D with the receiving surface 3, the leader remains held by the extrusion die, and the leader can then be applied to the receiving surface without suffering random folds.

The transverse profile of the band can be relatively varied as illustrated in FIG. 6 which depicts profile shapes usually used for winding on products. These standard shapes are designed to deliver the desired volume of elastomer to the receiving surface in each turn. FIG. 6 illustrates scenarios in which, starting from a straight shape in which the neutral fibre is rectilinear, the shape of the cross section has been curved in order to meet the requirements of the invention. The curved shape of identical section does not alter the laying rules, because of the magnitude of the radius of curvature and because of the action of the application roller which has the effect of pressing the band firmly against the receiving surface.

The teachings of the present description are not restricted merely to the manufacture of profiled elements by winding, and may obviously be extended to the solving of problems similar to the problem that the invention seeks to solve, namely control over the laying of a leader of a band of elastomer while avoiding the formation of a fold.

1. A method for laying a band of elastomer of given width (l)—and given mean thickness (e) on a receiving surface, comprising extruding through a die a leader of elastomer band of given length (s), the neutral fibre of the cross section of which has a non-zero curvature while said leader is supported only by an end positioned on the die side,
wherein the band is orientated in such a way that said neutral fibre has a concave side that faces away from the orientation of the gravitational field, thereby preventing the leader from collapsing under the effect of gravity.

2. The method according to claim 1, wherein the neutral fibre has a radius of curvature R that is greater than fifteen times the width of the band.

3. The method according to claim 1, wherein the width (l) to the thickness (e) are such that the ratio of l to e is between 3 and 30.

4. The method according to claim 3, wherein the ratio of the width (l) to the thickness (e) is between 5 and 20.

5. The method according to claim 1, wherein, for a band of given mean thickness (e), the length (s) of the leader is inversely proportional to the value of a radius of curvature (R) of the neutral fibre.

6. The method according to claim 1, further comprising bringing the extrusion means sufficiently close above the receiving surface so that a face of said leader which is positioned on the convex side of the convex neutral fibre is applied directly to said receiving surface.

7. The method according to claim 6, wherein the receiving surface is in relative motion with respect to the extrusion means.

8. The method according to claim 7, wherein the receiving surface is a rotating cylinder onto which turns of band are wound in a given order.
